(19) United States
(12) Patent Application Publication
(10) Pub. No.: US 2009/0232581 A1
(43) Pub. Date: Sep. 17, 2009

(54) Squeeze to write ink highlighter

(76) Inventor: Kun Yuan Tong, Suwanee, GA (US)

Correspondence Address: Kun Yuan Tong, 2842 Lowe Court, Suwanee, GA, 30024, US

(21) Appl. No.: 12/075,893

(22) Filed: Mar. 14, 2008

(51) Int. Cl. B43K 8/06

(52) U.S. Cl. 401/101; 401/198

(57) ABSTRACT

Squeeze to write ink highlighter comprises one cover and one ink bottle. The mechanism of squeezing to advance the ink bottle and releasing to retract the ink bottle is equipped inside the squeeze to write ink highlighter. User squeezes squeeze to write ink highlighter to write and releases squeeze to write ink highlighter to close the ink highlighter. Therefore user will never leave squeeze to write ink highlighter open and let ink dry out.

### BACKGROUND OF THE INVENTION

Ink highlighter has to be recapped after using. If user forgets to recap ink highlighter ink will dry out. If user holds it in hand and does not use it to write for one minute or two ink will dry out on the wick tip and it will be hard to use it to write. The present invented squeeze to write ink highlighter can solve this problems because if user does not squeeze it its cover will close spontaneously.

### THE BRIEF DESCRIPTION OF THE INVENTION

Squeeze to write ink highlighter has a device to advance its ink wick tip to open cover for writing when user squeezes it and its ink wick tip will retract to close its cover when user releases squeezing force. Therefore user uses only two fingers to squeeze or to release to control the opening and closure of ink highlighter.

### THE DETAILED DESCRIPTION OF THE INVENTION

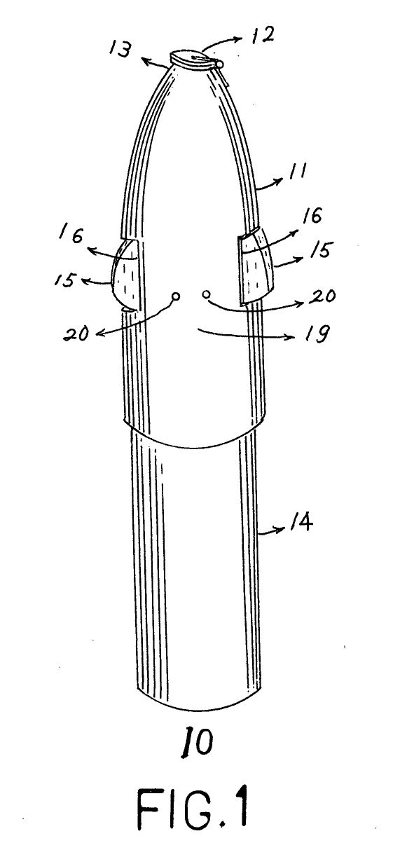

FIG. 1 is a perspective view of squeeze to write ink highlighter in closure status..

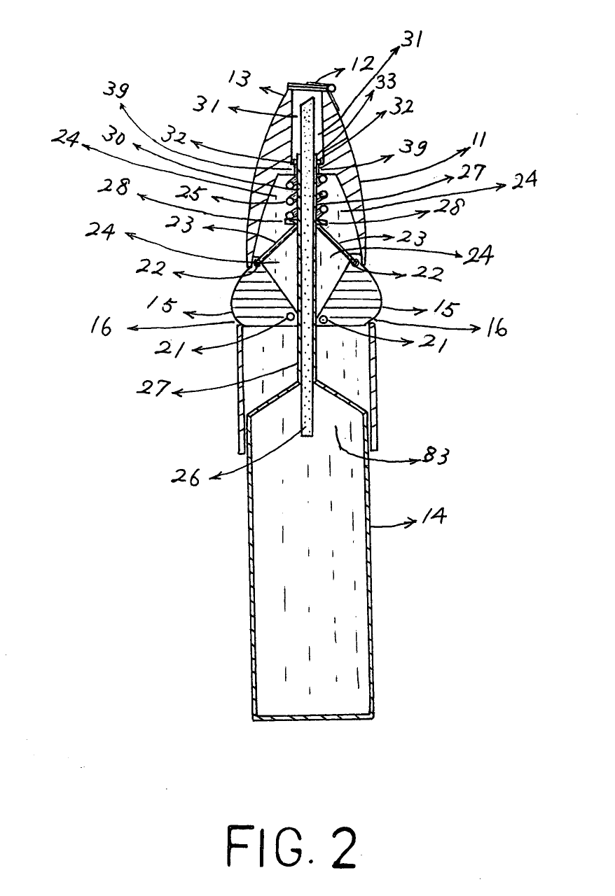

FIG. 2 is the dissection view of squeeze to write ink highlighter in closure status.

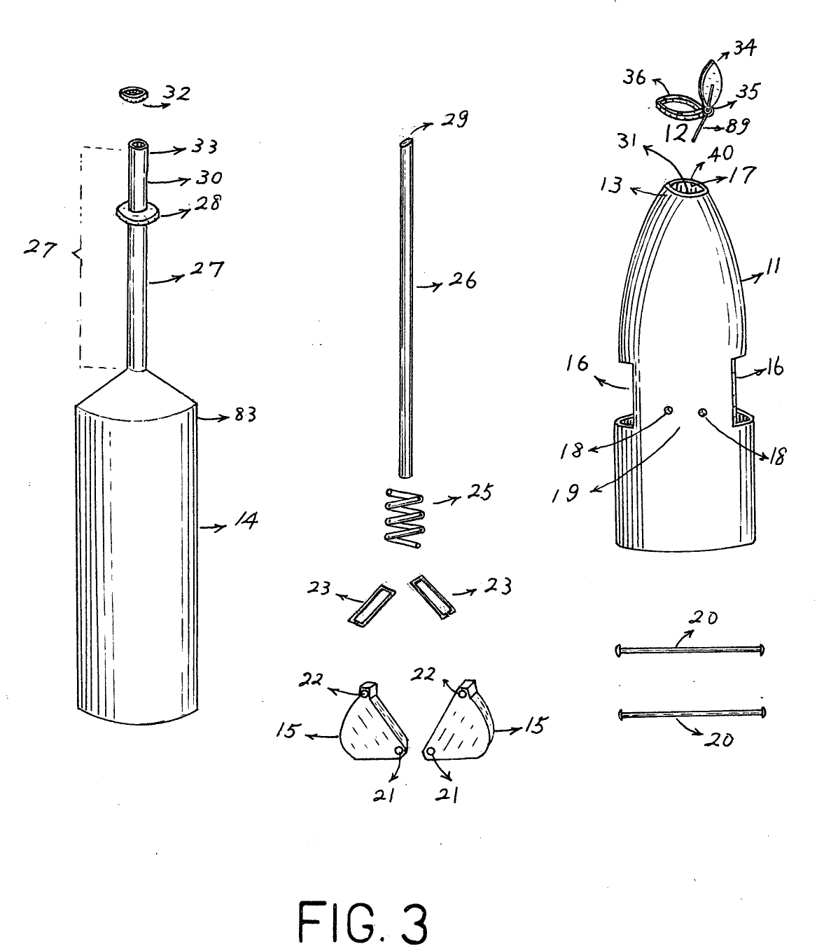

FIG. 3 is a perspective view of parts of squeeze to write ink highlighter.

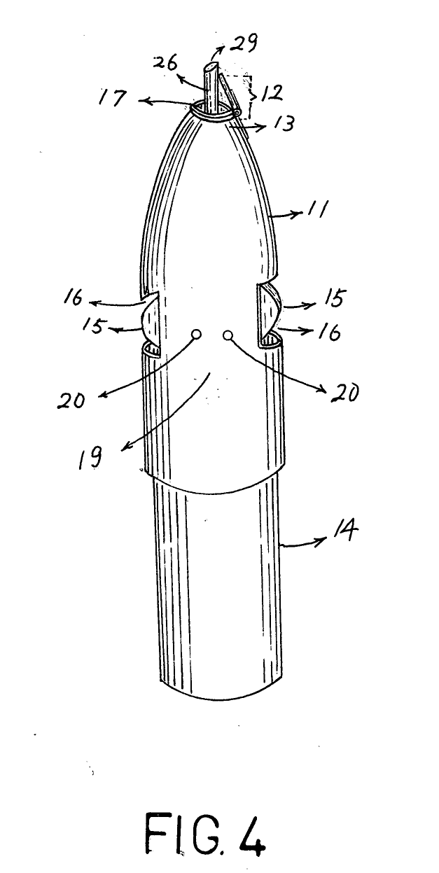

FIG. 4 is a perspective view of squeeze to write ink highlighter in open status.

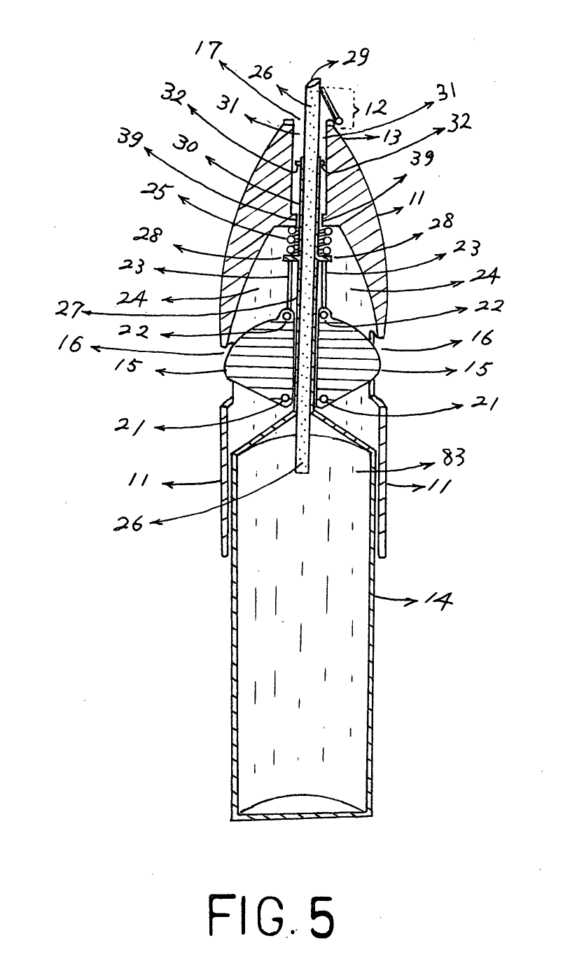

FIG. 5 is the dissection view of squeeze to write ink highlighter in open status.

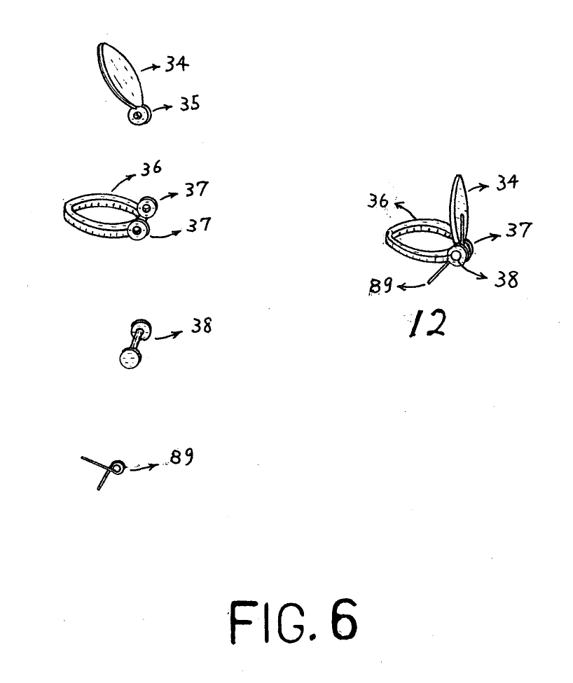

FIG. 6 is a perspective view of cap and its parts.

### THE DETAILED DESCRIPTION OF THE INVENTION

Referring now in detail to the drawings Numeral 10 of FIG. 1 is a squeeze to write ink highlighter. Numeral 11 of FIGS. 1, 2, 3, 4 and 5 is cover. Numeral 12 of FIGS. 1, 2, 3, 4, 5 and 6 is cover-cap that is installed at the tip 13 of cover 1I1 as illustrated in FIGS. 1, 2, 4 and 5. Numeral 14 of FIGS. 1, 2, 3, 4 and 5 is ink tube. Numeral 15 of FIGS. 1, 2, 3, 4 and 5 is squeeze button that is to be squeezed by finger. Numeral 16 of FIGS. 1, 2, 3, 4 and 5 is window of squeeze button 15. Numeral 17 of FIGS. 3, 4 and 5 is opening at the tip 13 of cover 11. Numeral 18 of FIGS. 3 is pin hole that locates at side wall 19 of cover 11. There are two pin holes on each side of side wall 19. Numeral 20 of FIGS. 1, 3 and 4 is pivot pin. There are two pivot pins. Numeral 21 of FIGS. 2, 3 and 5 is pivot pin hole of squeeze button 15. Numeral 22 of FIGS. 2, 3 and 5 is pusher hole on squeeze button 15. Numeral 23 of FIGS. 2, 3 and 5 is pusher. Pusher 23 is fastened at the pusher hole 22 on squeeze button 15 as illustrated in FIGS. 2 and 5. Numeral 24 of FIGS. 2 and 5 is a cone-shaped chamber that locates inside the rear portion of cover 11 and occupies about three fourths of total length of cover 11. Pivot pin 20 passes through pin hole 18 of one side of side wall 19, pivot pin-hole 21 of squeeze button 15 and comes out side hole 18 of another side of side wall 19 to fasten squeeze button 15 inside the cone-shaped chamber 24 of cover 11 as illustrated in FIGS. 2 and 5. Numeral 25 of FIGS. 2, 3 and 5 is spring coil. Numeral 26 of FIGS. 2, 3, 4 and 5 is wick. Numeral 27 of FIGS. 2, 3 and 5 is wick tip. Numeral 27 of FIGS. 2, 3 and 5 is wick tube. Wick 26 is installed inside wick tube 27 and ink tube 14 as illustrated in FIGS. 2 and 5. Numeral 28 of FIGS. 2, 3 and 5 is circular wing that locates at around the front one third portion of wick tube 27. Numeral 29 of FIGS. 2, 3 and 5 is the tip of wick 26. Pusher 23 rests at circular wing 28 as illustrated in FIGS. 2 and 5. Spring coil 25 encircles the front portion 30 of wick tube 27 and is placed against circular wing 28 as illustrated in FIGS. 2 and 5. Numeral 31 of FIGS. 2 and 5 is canal that locates in the center of the front portion of cover 11 and occupies about one fourth of the total length of cover 11. Canal 31 connects to cone-shaped chamber 24. Numeral 39 of FIGS. 2 and 5 is a circular ridge that locates at the bottom of canal 31 and at the top of cone-shaped chamber 24. Wick tube 27 is inserted through circular ridge 39 into canal 31 from cone-shaped chamber 24. Wick tip 29 and front portion 30 of wick tube 27 move freely forward and backward inside canal 31. Numeral 32 of FIGS. 2, 3 and 5 is sealing ring. Numeral 33 of FIG. 3 is the front end of the front portion 30 of wick tube 27.Sealing ring 32 is fixed at the front end 33 of the front portion 30 of wick tube 27 and rests on circular ridge 39 when squeeze to write ink highlighter is in closure status. Cover-cap 12 seals the opening 17 of cover 11 at above and sealing ring 32 seals the circular ridge 39 at bottom of canal 31 to create an air-tight canal 31 to prevent ink from evaporating when squeeze to write ink highlighter is at closure status. The first step to assemble squeeze to write ink highlighter is to insert spring coil 25 into the front portion 30 of wick tube 27. The second step is to insert wick tube 27 and spring coil 25 into circular ridge 39 and canal 31 through cone-shaped chamber 24. The third step is fasten pusher 23 onto push-hole 22 of squeeze button 15. The fourth step is to inset the unit of connected squeeze button 15 and pusher 23 into cone-shaped chamber 24 through squeeze button window and to place pusher 23 against circular wing 28. The fifth step is to align pivot pin-hole 21 with pin hole 18. The sixth step is to insert pivot pin 20 into pin hole 18 at one side wall 19 and pivot pin-hole 21 to comes out pin hole 18 at another side of side wall 19 to fasten squeeze button 15 inside cone-shaped chamber 24. Then both ends of pivot pin-hole 21 are flattened to secure it on side wall 19 of cover 11 as illustrated in FIGS. 1, 3 and 4. The last step is to fix sealing ring 32 onto front end 33 of the front portion of wick tube. Numeral 83 of FIGS. 2, and 5 is the front portion of ink tube 14. The front portion of ink tube 83 is inserted in the cone-shaped chamber 24 of cover 11 as illustrated in FIGS. 2 and 5. Pivot pin 20 acts as a pivot of squeeze button 15. When user presses downward squeeze button 15 pusher 23 advances to push circular wing 28 forward to push wick tip 29 coming out of opening 17 for writing. Numeral 34 of FIG. 6 is cap-cover that has a built-in cap-ring 35. Numeral 36 of FIG. 6 is cap base-ring that has two built-in ring buttons 37. Numeral 38 of FIG. 6 is cap-pin. Numeral 89 of FIG. 6 is spring wire coil. Cap-pin 38 passes through one ring button 37, spring wire coil 89, cap-ring 35 and another ring button 37 to fasten cap-cover 34 to cap base-ring 36. Numeral 40 of FIG. 3 is rim of opening 17 of cover 11. Cover-cap 12 is fixed to the rim 40 with adhesive or by other methods. Spring wire coil 89 presses cap-cover 34 against cover cap base-ring 36 to close opening 17.

1. Squeeze to write ink highlighter comprising a cap, a cover, a spring coil, two pushers, two squeeze buttons, two pivot pins, a sealing ring, a wick and an ink bottle.

2. The said cover in claim 1 is a cone-shaped cylinder that has a canal at the front portion that occupies about one fourth of the total length of the said cover, a big cone-shaped chamber at the rear portion that occupies about three fourths of the total length of the said cover and a circular ridge that locates at the lower end of the said canal and at the top of the said cone-shaped chamber. Wherein the said circular ridge provides a link between the said canal and the said cone-shaped chamber. Wherein the said big cone-shaped chamber has a rectangular window at each opposite side wall and at about the middle portion of it to install the said two squeeze buttons in claim 1. Wherein the said side cone-shaped chamber has also two side-holes on each side wall; each of hem is at about 70 degrees to the said rectangular windows and at the level near the back edges of the said rectangular windows.

3. The said cap in claim 1 is installed at the opening of the said canal in claim 2 to cover it and has a cap-cover, a cap base-ring, a cap-pin and a spring wire coil. Wherein the said cap-pin connects together and fastens the said cap-cover and the said spring wire coil to the said cap base-ring. Wherein the said spring wire coil presses the said cap-cover to close the said cap base-ring.

4. Each of the said two squeeze buttons in claim 1 is a triangle-shaped button that is installed inside the said rectangular window of the said cone-shaped chamber in claim 2 and has one hole at the edge of each of the two inner corners of the said triangle squeeze button. Wherein the front one of the said hole at the edge of the said two inner corners of the said triangle squeeze button installs one of the said two pusher in claim 1. Wherein the rear one of the said hole at the edge of the said two inner corners of the triangle squeeze button is fastened to the said cover in claims 1 and 2 by one of the said two pivot-pins in claim 1.

5. The said ink bottle in claim 1 has a slender wick tube at the top one half portion and a big ink tube at the bottom one half portion. Wherein the said slender wick tube has a built-in circular wing at about its top one third portion to catch the said two pushers in claim 1 and has the said sealing ring in claim 1 fixed at near its top end. Wherein the said slender wick tube contains the said wick in claim 1 and is inserted into the said canal of cover in claims 1 and 2. Wherein the said sealing ring rests on the said circular ridge in claim 2 when the said squeeze to write ink highlighter is in closure status. Wherein the said big ink tube contains portion of the said wick in claims 1 and 5 and color ink and its top portion is inserted inside the said cone-shaped chamber of the said cover in claim 2.

6. The said two pushers in claims 1 and 4 are rectangular wire loops or solid plates and their rear ends are fastened at the holes of the front edges of the said two inner corners of the said triangle squeeze button in claim 1 and 4. The two free front ends of the said pushers in claims 1 and 4 rest upon the said circular wing of the said wick tube of the said ink bottle in claims 1 and 5. Wherein the said two free front ends of the said two pushers in claim 1 push forward the said circular wing in claim 5 and the whole ink bottle in claim 1 to let the said wick in claims 1 and 5 protrude outside the opening of the said cover in claims 1 and 2 for writing when the said two squeeze buttons in claims 1, 4 and 6 are pressed by user's fingers.

7. The said spring coil in claim 1 encircles the front one third portion of said slender wick tube above the said circular wing in claim 5 and is installed inside the said cone-shaped chamber of cover in claim 2. Wherein the said spring coil pushes the said circular wing in claims 5 and 7 away from the said cone-shaped chamber of the said cover in claim 1 to against the said two pushers in claims 1, 4 and 6.

8. The said wick in claims 1 and 5 is stored inside the said slender wick tube and ink tube of the said ink bottle in claims 1 and 5.

9. The said sealing ring in claims 1 and 5 encircles and is fixed onto the near top portion of the said slender wick tube in claim 5. Wherein the said sealing ring rest upon the said circular ridge in claims 2 and 5 to seal circular ridge when the said squeeze to write ink highlighter is in closure status.

10. Each of the said two pivot pins in claim 1 passes through one of the said side holes of the said cone-shaped chamber in claim 2, the said hole at the edge of the rear inner corner of the said triangle squeeze button in claims 4 and 6 and one of the said side holes at the other side of the said side wall in claim 2 to fasten the said triangle squeeze buttons in claims 1, 4, 6 and 10 to the said side walls and inside the said cone-shaped chamber in claims 2, 4, 5 and 7.
